(19) United States
(12) Patent Application Publication
(10) Pub. No.: US 2007/0117588 A1
(43) Pub. Date: May 24, 2007

(54) Rejection of a call received over a first network while on a call over a second network

(75) Inventors: Glen S. Uehara, Gilbert, AZ (US); Harry H. Chow, Golden, CO (US); Richard E. Grams, Chandler, AZ (US); Hao A. Nguyen, Lake Worth, FL (US); Fred R. Villa, Gilbert, AZ (US)

Correspondence Address: CUENOT & FORSYTHE, L.L.C., 12230 FOREST HILL BLVD., SUITE 120, WELLINGTON, FL, 33414, US

(73) Assignee: Motorola, Inc.

(21) Appl. No.: 11/287,037

(22) Filed: Nov. 23, 2005

(51) Int. Cl. H04B 1/38

(52) U.S. Cl. 455/561; 455/550.1

(57) ABSTRACT

A mobile station (110) that includes a first network adapter (210) configured to communicate over a first communications network (120) and a second network adapter (220) configured to communicate over a second communications network (130). The mobile station also includes a multimodal processing module (250) that generates a busy notification in response to receiving a call via the second network adapter while the mobile station is engaged in a first call via the first network adapter. The busy notification can be automatically generated by the multimodal processing module in response to the second call being received, or generated in response to receiving a user input entered in response to the second call has been received.

### BACKGROUND OF THE INVENTION

1. Field of the Invention

The present invention generally relates to mobile communications and, more particularly, to communications over multiple communications networks.

2. Background of the Invention

With the widespread proliferation of mobile communications networks, consumers are now presented with various mobile communication services from which to choose. However, selection of a particular service is not always an easy decision. For example, some services offer free “mobile to mobile” calling between stations subscribing to the service, while other services offer discounted “push-to-talk” services. Accordingly, consumers would benefit from an ability to subscribe to multiple communication services using a single mobile station. The use of a station with multiple services would create a number of technical challenges, however.

If a station is subscribed both to a first communications network and a second communications network, the first and second communications networks may not be aware of each other. Accordingly, if the station is on a first call on the first communications network while a second call is received over the second communications network, the originator placing the second call may not receive an indication that the station is busy. Moreover, the second call may cause the station to ring, thus interrupting the first call.

### SUMMARY OF THE INVENTION

The present invention relates to a mobile station that includes a first network adapter configured to communicate over a first communications network and a second network adapter configured to communicate over a second communications network. The mobile station also includes a multimodal processing module that generates a busy notification in response to receiving a call via the second network adapter while the mobile station is engaged in a first call via the first network adapter. The busy notification can be automatically generated by the multimodal processing module in response to the second call being received, or generated in response to receiving a user input entered in response to the second call being received.

The busy notification can be propagated by the second network adapter, for example in a data burst. In one arrangement, the busy notification can include a message that is set in a data packet. In another arrangement, the busy notification can include an audio signal.

The busy notification can be propagated to a second station from which the second call originated or propagated. Alternatively, the busy notification can be propagated to a server communicatively linked to the second communications network. In this arrangement, the server can propagate a busy signal or audio message to the second station.

The present invention also relates to a method for handling an incoming call on a mobile station. The method can include propagating a busy notification indicating to a second station from which the second call originated that the mobile station is engaged in another call. The busy notification can be propagated in response to receiving a second call over a second communications network while the mobile station is engaged in a first call on a first communications network. The busy notification can be automatically generated in response to the second call being received, or generated in response to receiving a user input entered in response to the second call being received.

Propagating the busy notification can include transmitting the busy notification in a data burst. In one arrangement, propagating the busy notification can include a message in a data packet. In another arrangement, propagating the busy notification can include propagating an audio signal.

The busy notification can be propagated to the second station. In another arrangement, the busy notification can be propagated to a server communicatively linked to the second communications network. The server can propagate a busy signal or audio message to the second station.

Another embodiment of the present invention can include a machine readable storage being programmed to cause a machine to perform the various steps described herein.

### BRIEF DESCRIPTION OF THE DRAWINGS

Preferred embodiments of the present invention will be described below in more detail, with reference to the accompanying drawings, in which:

FIG. 1 depicts a communications system that is useful for understanding the present invention.

FIG. 2 depicts a block diagram that is useful for understanding the present invention.

FIG. 3 is flowchart that is useful for understanding the present invention.

### DETAILED DESCRIPTION

While the specification concludes with claims defining the features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

The present invention relates to a method and a system for handling an incoming call on a second communications network while a station is on a first call on a first communications network. In contrast to the prior art in which the communications network provides a busy signal or transfers the second call to voice mail when the station is busy on the first call call, the present invention implements a call handling routine on the station receiving the second call. The call handling routine can propagate a notification back to the originator of the second call, without interrupting the first call. The notification can be, for example, a busy signal, a message, or any other notification that alerts the originator of the second call that the station is on another call.

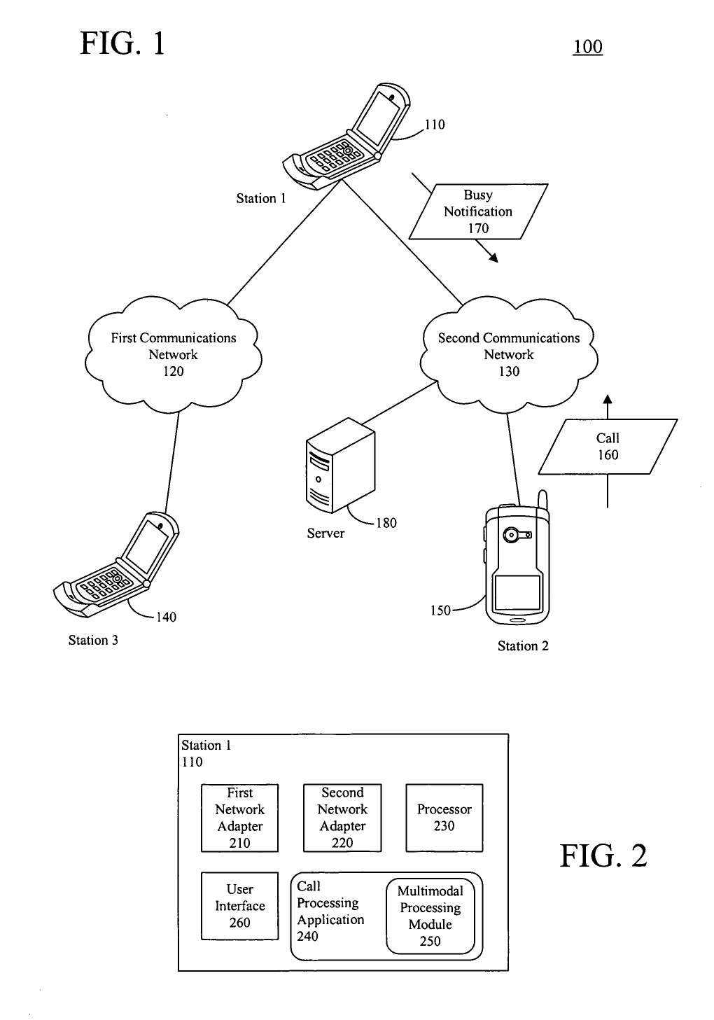

FIG. 1 depicts a communications system 100 that is useful for understanding the present invention. The communications system 100 can include a first station 110. The first station 110 can be a mobile station configured to communicate over both a first communications network 120 and a second communications network 130. In one arrangement, the first station 110 also can communicate over one or more additional communications networks (not shown).

The first communications network 120 can be, for example, a code division multiple access (CDMA) network. The second communications network 130 can be a type of communications network that is different than the first communications network, and/or a communications network that is operated by a different service provider. For instance, the second communications network 130 can be an integrated data enhanced network (iDEN). Notably, CDMA and iDEN are mere examples of networks with which the station 110 can communicate, and the invention is not limited in this regard.

In operation, the first station 110 can establish a communication link, or first call, with a third station 140. In response to receiving a call 160 from a second station 150 while the first station is engaged in the first call, the first station 110 can propagate a busy notification 170, which indicates to the second station 150 that the first station 110 is on another call. The busy notification 170 can be automatically generated by the first station 110, or generated in response to a user input on the first station 110. For example, an indication which prompts the user to enter the user input can be provided to the user when the second call is received.

The busy notification 170 can comprise any form of data which can be used to indicate to the second station 150 that the first station 110 is engaged in the call. For example, the data can be a message that is sent in a data frame or packet, or any other form data that can communicate a busy notification. The busy notification 170 can be transmitted in a data burst to minimize use of network bandwidth. A data burst can be a transport of data over existing network channels. For instance, data packets containing the data can be formatted into a data burst message that is then transported over an appropriate physical channel. In an arrangement in which the call 160 is a dispatch call, a data over dispatch voice signal can be propagated to the second station 150. The second station 150 can be configured to recognize the busy notification 170. For instance, the second station 150 can comprise a software application that processes the busy notification 170 in a suitable manner.

In another arrangement a server 180 communicatively linked to the second communications network 130 can receive the busy notification 170, process the busy notification 170 using a suitable application, and propagate a correlating busy signal or audio message to the second station 150. This arrangement can be beneficial when the second station is a legacy communications device, such as a standard telephone or a mobile station which does not include a software application for specifically processing the busy notification 170.

In yet another arrangement, the busy notification 170 can comprise an audio message, such as a personal message from the user of the first station 110 or a busy signal. In this arrangement, the first station 110 can ignore audio signals transmitted by the second station 150. This arrangement also can be beneficial when the second station 150 is a legacy communications device.

FIG. 2 depicts a block diagram of the first station 110. The first station 110 can include a first network adapter 210 for communicating over the first communications network and a second network adapter 220 for communicating over the second communications network. The network adapters 210, 220 can support IEEE 802 wireless communications, WPA, WPA2, GSM, TDMA, CDMA, WCDMA, Bluetooth, direct wireless communication, TCP/IP, or any other communications protocols compatible with the communications networks to which the station 110 is linked.

The first station 110 also can include a processor 230 which can process a call processing application 240. The processor 230 can include a central processing unit (CPU), a digital signal processor (DSP), an application specific integrated circuit (ASIC), a programmable logic device (PLD), a plurality of discrete components that cooperate to process data, and/or any other suitable processing device.

The call processing application 240 can be an application executable by the processor 230 to process calls on the first station 110. The call processing application 240 can include a multimodal processing module 250. The multimodal processing module 250 can coordinate communications between the first station 110 and other stations with which the first station 110 communicates over the communications networks. For instance, the multimodal processing module 250 can detect the incoming call on the second network adapter 220 when the first station is engaged in a call with the third station.

In response to detecting the incoming call, the multimodal processing module 250 can automatically generate the busy notification and cause the busy notification to be propagated to the second station via the second network adapter 220. Alternatively, the multimodal processing module 250 indicate to a user of the mobile station 110 that a second call is being received. The user then can choose to enter a user input via a user interface 260 to cause the multimodal processing module 250 to generate the busy notification and cause the notification to be propagated. The user input can be, for example, a tactile activation of a button, key or soft-key. If the station 110 comprises a voice recognition application, the user input can be a spoken utterance. If the user does not enter a user input, the second call can be ignored.

In one arrangement, settings in the multimodal processing module 250 can be accessed via the user interface 260 of the station 110. For example, whether to activate the multimodal processing module 250 and whether to automatically propagate the busy notification can be user selectable options. A user can turn on the multimodal processing module 250 by setting a busy notification flag to a particular value, or turn off the multimodal processing module 250 by setting the busy notification flag to a different value. In addition, the user can set an automatic response flag to automatically generate a busy notification when a second call is received while the user is on a first call, or to wait for a user input.

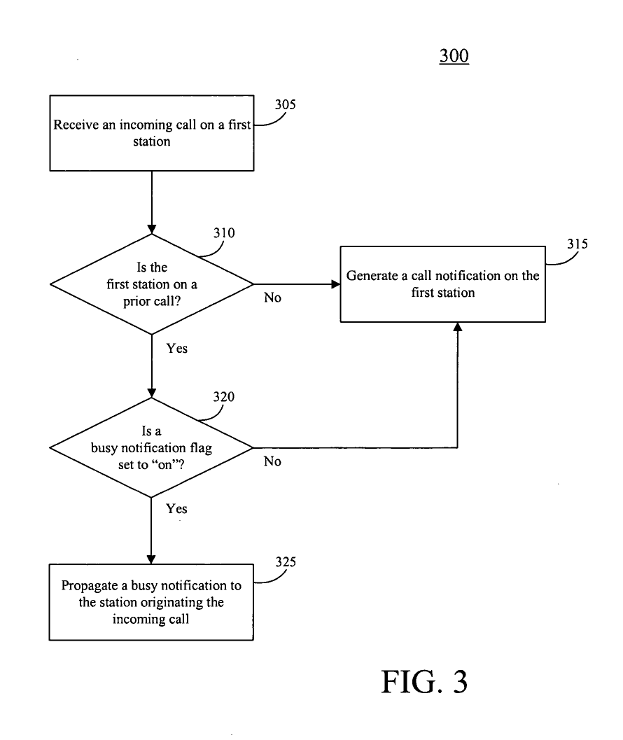

FIG. 3 is flowchart that presents a method 300 which is useful for understanding the present invention. Beginning at step 305, an incoming call can be received on the first station. Referring to decision box 310, if the first station is not engaged in another call, a call notification, such as a ring tone or vibration, can be generated on the first station, as shown in step 315. If, however, the first station is engaged in a prior call, the process can proceed to decision box 320. If the busy notification flag is set to “on”, the process can proceed to step 325 and a busy notification can be propagated to the station originating the incoming call. The busy notification can be sent automatically or sent in response to a user input. If the busy notification flag is set to “off”, the process can proceed to step 315 and a call notification can be generated on the first station.

The present invention can be realized in hardware, software, or a combination of hardware and software. The present invention can be realized in a centralized fashion in one processing system or in a distributed fashion where different elements are spread across several interconnected processing systems. Any kind of processing system or other apparatus adapted for carrying out the methods described herein is suited. A typical combination of hardware and software can be a general-purpose processing system with an application that, when being loaded and executed, controls the processing system such that it carries out the methods described herein. The present invention also can be embedded in a application product, which comprises all the features enabling the implementation of the methods described herein, and which when loaded in a processing system is able to carry out these methods.

The terms “computer program”, “software”, “application”, variants and/or combinations thereof, in the present context, mean any expression, in any language, code or notation, of a set of instructions intended to cause a system having an information processing capability to perform a particular function either directly or after either or both of the following: a) conversion to another language, code or notation; b) reproduction in a different material form. For example, an application can include, but is not limited to, a subroutine, a function, a procedure, an object method, an object implementation, an executable application, an applet, a servlet, a source code, an object code, a shared library/dynamic load library and/or other sequence of instructions designed for execution on a computer system.

The terms “a” and “an,” as used herein, are defined as one or more than one. The term “plurality”, as used herein, is defined as two or more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically, i.e. communicatively linked through a communication channel or pathway.

This invention can be embodied in other forms without departing from the spirit or essential attributes thereof. Accordingly, reference should be made to the following claims, rather than to the foregoing specification, as indicating the scope of the invention.

What is claimed is:

1. A mobile station, comprising:
a first network adapter configured to communicate over a first communications network;
a second network adapter configured to communicate over a second communications network; and
a multimodal processing module that generates a busy notification that is propagated by the second network adapter in response to receiving a call via the second network adapter while the mobile station is engaged in a first call via the first network adapter.

2. The mobile station of claim 1, wherein the multimodal processing module automatically generates the busy notification in response to the second call being received.

3. The mobile station of claim 1, wherein the multimodal processing module generates the busy notification in response to receiving a user input entered in response to the second call being received.

4. The mobile station of claim 1, wherein the busy notification comprises a message that is sent in a packet or frame.

5. The mobile station of claim 1, wherein the mobile station transmits the busy notification in a data burst.

6. The mobile station of claim 1, wherein the busy notification is propagated to a second station from which the second call originated.

7. The mobile station of claim 1, wherein the busy notification is propagated to a server communicatively linked to the second communications network, the server propagating a busy signal or audio message to a second station from which the second call originated.

8. The mobile station of claim 1, wherein the busy notification comprises an audio signal that is propagated to a second station from which the second call originated.

9. A method for handling an incoming call on a mobile station, comprising:
responsive to receiving a second call over a second communications network while the mobile station is engaged in a first call on a first communications network, propagating a busy notification indicating to a second station from which the second call originated that the mobile station is engaged in another call.

10. The method according to claim 9, wherein propagating the busy notification comprises automatically generating the busy notification in response to the second call being received.

11. The method according to claim 9, wherein propagating the busy notification comprises generating the busy notification in response to receiving a user input entered in response to the second call being received.

12. The method according to claim 9, wherein propagating the busy notification comprises sending a message in a packet or frame.

13. The method according to claim 9, wherein propagating the busy notification comprises transmitting the busy notification in a data burst.

14. The method according to claim 9, wherein propagating the busy notification comprises propagating the busy notification to the second station.

15. The method according to claim 9, wherein propagating the busy notification comprises propagating the busy notification to a server communicatively linked to the second communications network, the server propagating a busy signal or audio message to the second station.

16. The method according to claim 9, wherein propagating the busy notification comprises propagating an audio signal to the second station.

17. A machine readable storage, having stored thereon an application having a plurality of code sections executable by a machine for causing the machine to perform the step of:
responsive to receiving a second call over a second communications network while the mobile station is engaged in a first call on a first communications network, propagating a busy notification indicating to a second station from which the second call originated that the mobile station is engaged in another call.

18. The machine readable storage of claim 17, wherein propagating the busy notification comprises automatically generating the busy notification in response to the second call being received.

19. The machine readable storage of claim 17, wherein propagating the busy notification comprises generating the busy notification in response to receiving a user input after the second call has been received.

20. The machine readable storage of claim 17, wherein propagating the busy notification comprises sending a message in a packet or frame.
